(19) United States
(12) Patent Application Publication
(10) Pub. No.: US 2008/0298769 A1
(43) Pub. Date: Dec. 4, 2008

(54) METHOD AND SYSTEM FOR GENERATING COMPRESSED VIDEO TO IMPROVE REVERSE PLAYBACK

(76) Inventors: Neil Johnson, Cambridge (GB); Robert Swann, Cambridge (GB); Richard Bruce Griffiths, Cambridge (GB); Kevin Bracey, Cambridge (GB)

Correspondence Address: MCANDREWS HELD & MALLOY, LTD, 500 WEST MADISON STREET, SUITE 3400, CHICAGO, IL, 60661, US

(21) Appl. No.: 11/757,694

(22) Filed: Jun. 4, 2007

(51) Int. Cl. H04N 5/91

(52) U.S. Cl. 386/68

(57) ABSTRACT

The disclosed systems and methods achieve improved quality reverse playback of video though techniques for modifying the way in which video is encoded and stored. The methods and systems may be used, for example, in conjunction with a wide variety of media playing and recording devices, such as DVD recorders, set top boxes, personal video devices (PVR), and mobile phones. Any device that allows users to record video, either from a fixed source (e.g., set top box) or from life (e.g., mobile phone with built-in video camera, or a standard digital video camera), may use the disclosed methods and systems to give users a higher quality playback.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Digital video is encoded according to the ordering of video frames in the forward direction of playback. Reverse playback may, therefore, be a very compute-intensive process, which requires more power than forward playback. Moreover, reverse playback of video may result in very low video quality because the high computational complexity and/or memory usage demanded by conventional reverse-play techniques can cause video frames to be omitted or displayed at the wrong time, leading to a jerky display

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for reverse playback of a video stream, substantially as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for generating compressed video in accordance with a representative embodiment of the present invention;

FIG. 2 is a block diagram of an exemplary system for generating compressed video in accordance with an embodiment of the present invention;

FIG. 3 is an illustration of a first exemplary storage sequence for compressed video in accordance with an embodiment of the present invention; and

FIG. 4 is an illustration of a second exemplary storage sequence for compressed video in accordance with an embodiment of the present invention.

### DETAILED DESCRIPTION OF THE INVENTION

Aspects of the present invention relate to technique for modifying the way in which video is encoded to improve its quality when viewed in reverse. The following methods and systems may be used, for example, in conjunction with a wide variety of media playing and recording devices, such as DVD recorders, set top boxes, personal video devices (PVR), and mobile phones. Any device that allows users to record video, either from a fixed source (e.g., set top box) or from life (e.g., mobile phone with built-in video camera, or a standard digital video camera), may use the following methods and systems to give users a higher quality playback.

Although the following description may refer to particular standards, many other standards may also use these systems and methods.

Video is compressed in the forward direction while preserving image quality through a combination of spatial and temporal compression techniques. A video encoder may generate different types of coded frames. For example, MPEG-4 encodes three types of coded frames: Intra-coded (I), Predictive (P), and Bi-directional (B) frames. An I-frame is encoded independently of other frames based on a Discrete Cosine Transform (DCT), quantization, and entropy coding. I-frames are referenced during the encoding of other frame types and are coded with the least amount of compression. P-frame coding includes motion compensation with respect to the previous I or P-frame. A B-frame is an interpolated frame that requires both a past and a future reference frame (I or P). Typically, I-frames require more bits than P-frames, and P-frames require more bits than B-frames. Since P- and B-frames are generally much smaller than I-frames a compression advantage comes from having multiple P- and B-frames for every I-frame. After coding, the frames are arranged in a deterministic periodic sequence, for example “IBBBPBBBPBBB”, which is called a Group of Pictures (GOP).

Playing a video stream in the forward direction consists of presenting an I-frame to the display, and then applying successive P- and B-frames at the required frame rate. Each P- and B-frame describes how the current image should be modified to produce the next complete frame in the video sequence.

Reverse viewing (rewind, review), however, requires considerable computation in order to build each complete frame from the preceding I-frame and any preceding P-frames. B-frames, since they are bi-directional, may be used in forward and reverse playback. If a GOP contains a number, N, of P-frames for every I-frame, building frames in the reverse direction requires on average the processing of one I-frame and N/2 P-frames for every complete frame. In the best scenario one I-frame must be processed. However, the worst case requires the processing of one I-frame and N P-frames. It may not be possible to store the decoded P-frames for use when decoding subsequent frames because sufficient memory may not be available on the device.

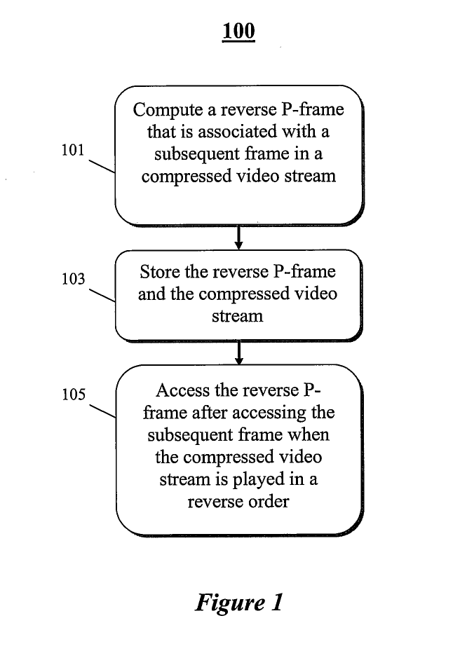

FIG. 1, 100, is a flowchart illustrating an exemplary method for generating compressed video. In forward playback of a compressed video stream, a displayed video image may be based on a current P-frame and a previous I-frame. If the compressed video stream is to be played in reverse, a reverse P-frame is computed at step 101. The reverse P-frame will be associated with a subsequent I-frame in the compressed video stream. The reverse P-frame may be computed as the compressed video stream is received and/or played. The computation of a reverse P-frame may be based on the difference that is calculated between a current frame and the next I-frame in the video stream. The current frame is based on a current P-frame and the most recent prior I-frame. Alternatively, the reverse P-frame may be computed by transforming the current P-frame.

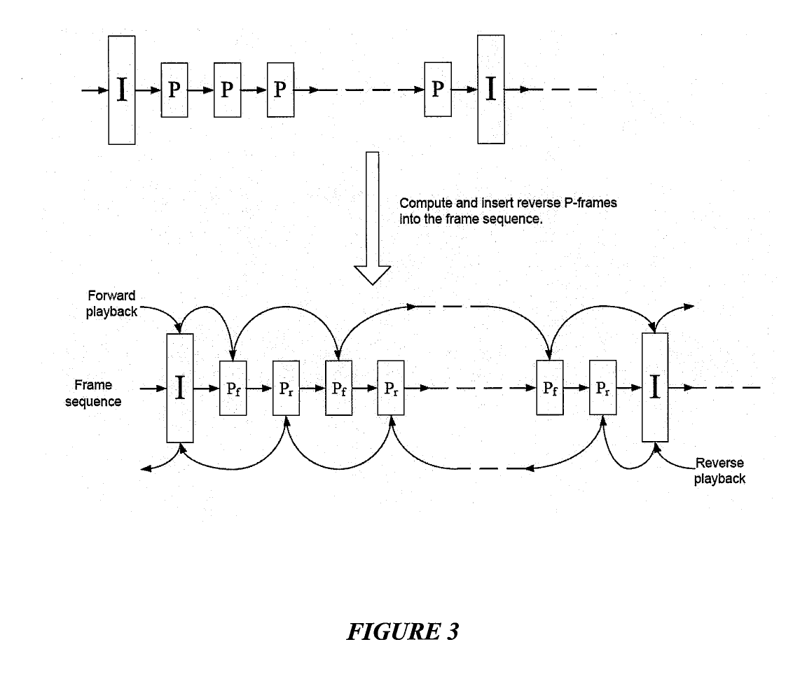

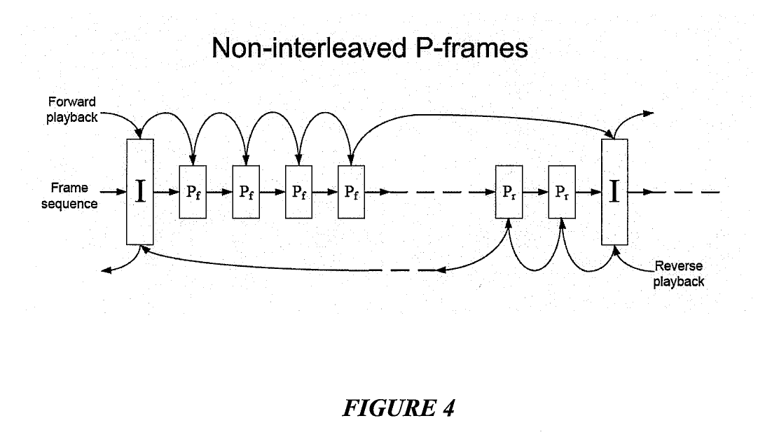

At step 103, the reverse P-frame and the compressed video stream are stored on, for example, a local storage media, such as a hard disk or flash memory. Since no additional I-frames are required, the increase in data storage requirements may be limited to doubling the P-frame storage requirements. When the reverse P-frames, Pᵣ, are stored, they may be interleaved between forward P-frames, P_{f}, as illustrated in FIG. 3. Alternatively, the forward P-frames and the reverse P-frames may be stored in separate blocks as illustrated in FIG. 4.

At step 105, the reverse P-frame may be accessed after the associated I-frame when the compressed video stream is played in a reverse order. During reverse playback, forward P-frames may be ignored and reverse P-frames may be accessed as if they were forward P-frames. Therefore, the processing during reverse playback may be comparable to the processing during forward playback.

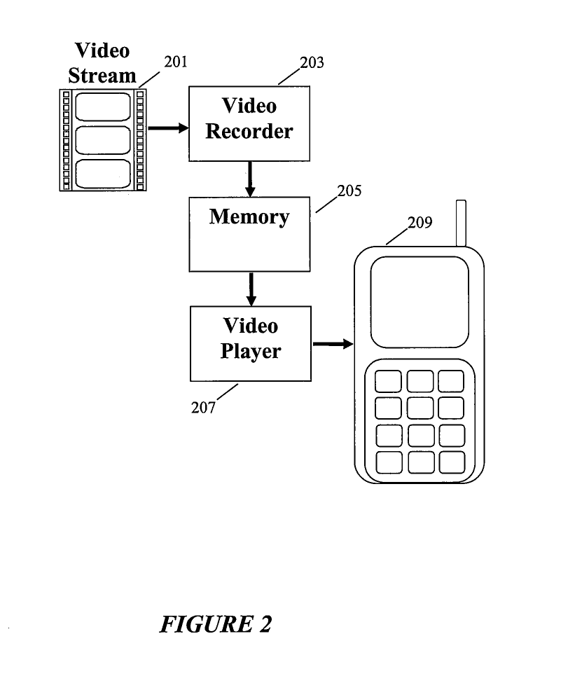

FIG. 2 is a block diagram of an exemplary system for generating compressed video. The system comprises a video recorder, 203, a memory, 205, and a video player, 207. The video recorder, 203, computes a reverse P-frame, which is associated with a subsequent frame in a compressed video stream, 201. The video recorder may compute the reverse P-frame as the compressed video stream is received based on the difference between the subsequent frame and a current complete frame. The current complete frame is associated with a prior I-frame and a current forward P-frame. The reverse P-frame may also by computed directly by transforming the current forward P-frame.

The memory, 205, stores the reverse P-frame and the compressed video stream, 201. The reverse P-frame may be interleaved among a plurality of forward P-frames in the memory as illustrated in FIG. 3. Alternatively, the reverse P-frame may be stored in a block of the memory apart from the forward P-frames as illustrated in FIG. 4.

The video player, 207, may access the reverse P-frame after accessing the subsequent frame when the compressed video stream is played in reverse on a media device, 209.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for generating compressed video, wherein the method comprises:
computing a reverse predictive frame, wherein the reverse predictive frame is associated with a subsequent frame in a compressed video stream;
storing the reverse predictive frame and the compressed video stream; and
accessing the reverse predictive frame after accessing the subsequent frame when the compressed video stream is played in a reverse order.

2. The method of claim 1, wherein the reverse predictive frame is computed as the compressed video stream is received.

3. The method of claim 1, wherein the reverse predictive frame is computed from the difference between the subsequent frame and a current complete frame.

4. The method of claim 3, wherein the current complete frame is based on a prior intra-coded frame and a current forward predictive frame.

5. The method of claim 1, wherein the reverse predictive frame is computed by transforming a forward predictive frame.

6. The method of claim 1, wherein the reverse predictive frame is stored between a pair of forward predictive frames.

7. The method of claim 1, wherein the reverse predictive frame is stored in a block of memory separate from a plurality of forward predictive frames.

8. A system for generating compressed video, wherein the system comprises:
a video recorder for computing a reverse predictive frame, wherein the reverse predictive frame is associated with a subsequent frame in a compressed video stream;
a memory for storing the reverse predictive frame and the compressed video stream; and
a video player for accessing the reverse predictive frame after accessing the subsequent frame when the compressed video stream is played in a reverse order.

9. The system of claim 8, wherein the video recorder computes the reverse predictive frame as the compressed video stream is received.

10. The system of claim 8, wherein the video recorder computes the reverse predictive frame from the difference between the subsequent frame and a current complete frame.

11. The system of claim 10, wherein the current complete frame is based on a prior intra-coded frame and a current forward predictive frame.

12. The system of claim 8, wherein the video recorder computes the reverse predictive frame by transforming a forward predictive frame.

13. The system of claim 8, wherein the reverse predictive frame is interleaved among a plurality of forward predictive frames in the memory.

14. The system of claim 8, wherein the reverse predictive frame is stored in a first block of the memory and a plurality of forward predictive frames are stored in a second block of the memory.
